(19) United States
(12) Patent Application Publication
(10) Pub. No.: US 2019/0299573 A1
(43) Pub. Date: Oct. 3, 2019

(54) Protective Film, Protective Film Laminate, and Method of Making Same

(71) Applicant: The Color Spot, Inc., Marietta, GA (US)

(72) Inventor: Jonathan Baltuch, Marietta, GA (US)

(21) Appl. No.: 16/170,269

(22) Filed: Oct. 25, 2018

Related U.S. Application Data
(60) Provisional application No. 62/650,548, filed on Mar. 30, 2018.

(51) Int. Cl. B32B 27/08; B32B 27/32; B32B 38/00; B32B 7/12; B32B 37/12; C09J 7/24; C09J 5/04

(52) U.S. Cl. CPC B32B 27/08; B32B 27/322; B32B 38/145; B32B 7/12; B32B 37/1284; C09J 7/243; C09J 2427/008; B32B 2307/41; B32B 2327/18; B32B 2519/00; B32B 2307/414; B32B 2405/00; B32B 2451/00; C09J 5/04

(57) ABSTRACT

A protective film laminate for attachment to a surface may include, for example, a self-adhesive polymeric film having a display surface on a first side and a first adhesive on a second side for attachment to the surface; and a clear polymeric film having a first side and a second adhesive on a second side, the second side of the clear polymeric film being laminated onto the first side of the self-adhesive polymeric film via the second adhesive thereby forming the protective film laminate.

### CROSS REFERENCE TO RELATED APPLICATION

The present application is a Non-Provisional patent application and claims priority to U.S. Provisional Patent Application Ser. No. 62/650,548, filed Mar. 30, 2018, which is incorporated by reference herein.

### TECHNICAL FIELD

The present disclosure relates generally to a protective film, a protective film laminate, and a method of making such a film or laminate.

### BACKGROUND

Vehicles are generally painted for decoration and protection of underlying surfaces, which may be metals (e.g., steel or aluminum), plastics, composites, etc. Some surfaces are simply painted a solid color, while other surfaces are painted with multiple colors, details, features, etc. Painted surfaces generally include several layers, including undercoats or primer coats, “regular” paint coats, and protective (typically clear) topcoats. Parts or sometimes all of vehicles, particularly commercial vehicles, may also be painted with information such as company names, product names, contact information, slogans, logos, graphical decoration or advertisements, etc. Also, plastic films have been developed to “wrap” fully or decorate partially vehicles. Such wraps have typically been made of a vinyl film. Similar plastic films have also been adapted for covering and decorating non-vehicle surfaces as well.

While existing paint and wraps work reasonably well for their intended purposes, they are subject to some drawbacks. For example, where vehicles are used in particularly dirty or corrosive environments (e.g., in commercial vehicles such as construction vehicles, garbage vehicles, etc.), the painted or wrapped surfaces can be damaged by contact with corrosive liquids seeping along and through the various layers atop the surfaces, can be damaged by contact with solid objects that come into contact, or can be damaged by vandalism (e.g., spray paint or indelible ink markers). In such situations, degradation of the painted or wrapped surface can occur, and degradation of the underlying surface (i.e., rust) can also occur if proper care is not taken to inspect, clean, and or repair such surfaces on a regular basis. Also, many existing surfaces, paints, and wraps are difficult or impossible to clean without substantial damage.

Thus, while existing protective films, laminates and methods generally work for their intended purposes, improvements to such films, laminates, and/or methods that were cost effective, easier to apply or clean, less cumbersome, and/or that addressed one of the drawbacks of existing films, laminates or methods, and/or other issues, would be welcome.

### SUMMARY

According to certain aspects of the disclosure, a protective film laminate for attachment to a surface may include, for example, a base layer having a first side and a second side, the base layer including a polymeric film; a top layer having a first side and a second side, the top layer including a clear polymeric film; a first adhesive layer located on the second side of the base layer for adhering to the surface; and a second adhesive layer located on the second side of the top layer, the second adhesive layer adhering the second side of the top layer with the first side of the base layer thereby creating the protective film laminate. Various options and modifications are possible.

For example, the clear polymeric film may be transparent, and may include a fluoropolymer, which may be ethylene tetrafluoroethylene.

The first adhesive may include a pressure-sensitive adhesive, and the second adhesive includes a pressure-sensitive adhesive and a UV-light blocker.

The laminate may further include a protective layer removably attached to the base sheet via the first adhesive layer for covering the first adhesive layer until contact with the surface. The second side of the top layer may have a corona treated surface.

The first side of the base layer may include decoration, color(s), and/or visible indicia thereon. The visible indicia may include digitally printed ink.

The polymeric film may include vinyl, such as a polyvinylchloride.

According to other aspects of the disclosure, a protective film laminate for attachment to a surface may include, for example, a self-adhesive polymeric film having a display surface on a first side and a first adhesive on a second side for attachment to the surface; and a clear polymeric film having a first side and a second adhesive on a second side, the second side of the clear polymeric film being laminated onto the first side of the self-adhesive polymeric film via the second adhesive thereby forming the protective film laminate. As above, various options and modifications are possible.

For example, the clear polymeric film may include a fluoropolymer, such as ethylene tetrafluoroethylene.

The first adhesive may include a pressure-sensitive adhesive, and the second adhesive may include a pressure-sensitive adhesive and a UV-light blocker.

A protective layer may be removably attached to the self-adhesive polymeric film via the first adhesive layer for covering the first adhesive layer until contact with the surface. The second side of the clear polymeric film may have a corona treated surface.

The display surface of the base layer may include visible indicia thereon, such as digitally printed ink.

The self-adhesive polymeric film may include vinyl, such as polyvinylchloride.

According to still other aspects of the disclosure, a method of forming a protective film laminate may include the steps of applying a first adhesive to a side of a polymeric film; applying a second adhesive to a side of clear polymeric film; and laminating together the polymeric film and the clear polymeric film via the second adhesive. Again, various options and modifications are possible.

For example, the method may further include the step of removably attaching a protective base sheet to the polymeric film via the first adhesive, and the removably attaching step may occur before the laminating together step.

The method may also further include removing the protective base sheet from the polymeric film, and/or applying visible indicia on a side of the polymeric film opposite the side on which the first adhesive is applied. The applying visible indicia step may include printing the visible indicia.

The clear polymeric film may include a fluoropolymer, such as ethylene tetrafluoroethylene.

The first adhesive may include a pressure-sensitive adhesive, and the second adhesive may include a pressure-sensitive adhesive and a UV-light blocker. The method may further include corona treating the side of the clear polymeric film.

The polymeric film may include vinyl, such as polyvinylchloride.

### BRIEF DESCRIPTION OF THE DRAWINGS

These and other features of the disclosure will be more readily understood from the following detailed description of the various aspects of the disclosure taken in conjunction with the accompanying drawings that depict various aspects of the disclosure.

FIG. 1 is a cross-sectional view of a laminate according to certain aspects of the disclosure as attached to a surface.

FIG. 2 is a schematic representational view of a method of creating a laminate according to certain aspects of the disclosure.

FIG. 3 is an isometric view of a vehicle on which several pieces of laminate according to certain aspects of the disclosure are attached.

FIG. 4 is an isometric view of a fixed item such as a kiosk on which several pieces of laminate according to certain aspects of the disclosure are attached.

### DETAILED DESCRIPTION

Detailed reference will now be made to the drawings in which examples embodying the present disclosure are shown. The detailed description uses numeral and letter designations to refer to features in the drawings. Like or similar designations in the drawings and description have been used to refer to like or similar parts of the disclosure.

The drawings and detailed description provide a full and enabling description of the disclosure and the manner and process of making and using it. Each embodiment is provided by way of explanation of the subject matter not limitation thereof. In fact, it will be apparent to those skilled in the art that various modifications and variations may be made to the disclosed subject matter without departing from the scope or spirit of the disclosure. For instance, features illustrated or described as part of one embodiment may be used with another embodiment to yield a still further embodiment.

Generally speaking, the present disclosure is directed to aspects of films, film laminates, and methods for manufacturing same. The films, laminates, and/or individual layers provide protection for surfaces on which they are mounted, ready cleanup when soiled, resistance to damage or corrosion, and informational or decorational utility. The laminate can include a self-adhesive layer, covered by a removable peel-away backing layer if desired, for easy application to a desired surface. The laminate could also be attached via “cling” properties, separately applied adhesives (not pre-supplied on the laminate), heating, stretching, or other methods and/or materials.

As shown in FIG. 1, a protective film laminate 10 for attachment to a surface 20 may include, for example, a top layer 12 and a base layer 14. An adhesive 16 may be located between top layer 12 and base layer 14, and another adhesive 18 may be located between base layer 14 and surface 20.

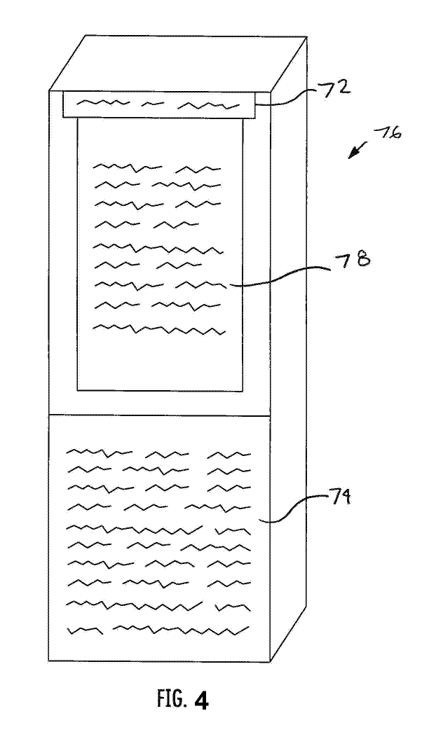

It should be understood that surface 20 can be any desired surface for which decoration and/or protection is desired, such as a vehicle (see an example in FIG. 3) or another surface (see an example in FIG. 4). Depending on the intended application, different choices can be made for the films and/or the adhesives. In particular, the adhesive chosen as adhesive 18 used to connect base layer 14 to surface 20 may vary depending on the makeup and location of the surface (indoor, outdoor, metal, plastic, painted, unpainted, in or out of direct sun, in or out of liquid or chemical moisture, subject to contact or not subject to contact, etc.). Thus, no limitation on surface 20 or adhesive 18 used to attach laminate 10 to surface should be implied based on the examples identified herein.

Base layer 14 is a film with desired content to be placed on surface 20. For example, base layer 14 may be a film having one or more colors, a decorated film with words, graphics, pictures, etc., on a clear or colored background, etc. Thus, base layer 14 could comprise any desired covering for surface 20.

In some embodiments, base layer 14 may comprise a film including a vinyl, such as a polyvinylchloride (PVC). The film may be those of the type available from vendors such as 3M Corp., Avery Dennison, etc., and may be selected in terms of type and thickness based on manufacturer's specifications for suitability with the surface and environmental application upon which it is to be used. Base layer 14 may be said to include a first, upper side 22 and a second, lower side 24. Indicia, decoration, etc. may be located on first side 22, and adhesive 18 may be located on second side 24.

Top layer 12 is a transparent or translucent protective cover layer of laminate 10. It can be said that top layer 12 has a first, upper side 26 and a second, lower side 28. Adhesive 16 is located on second side 28 of top layer 12.

In some embodiments, top layer 12 is a film such as a fluoropolymer, which may be ethylene tetrafluoroethylene, for example available from TCI (Textiles Coated International). Such a film may be employed, for example, in a thickness on the order of about 1 mil, and may be plasma/corona treated on the second side to allow for use with adhesives. It should be understood that other parameters for such film and other films may be used for top layer 12, if desired.

Both first adhesive 16 and second adhesive 18 may be pressure-sensitive adhesives, and the second adhesive may include a UV-light blocker to protect base layer 14 and any indicia thereon such as printed matter or the like.

The laminate 10 may further include a protective layer (discussed in more detail below) removably attached to base layer 14 via adhesive 18 for covering the adhesive layer until contact with the surface 20. A similar protective layer may be employed during manufacture of laminate 10 on second side 28 of top layer 12. Such layers may be for example, removable paper or plastic layers, secured in place via the respective adhesives and readily peelable via a machine or manually when desired.

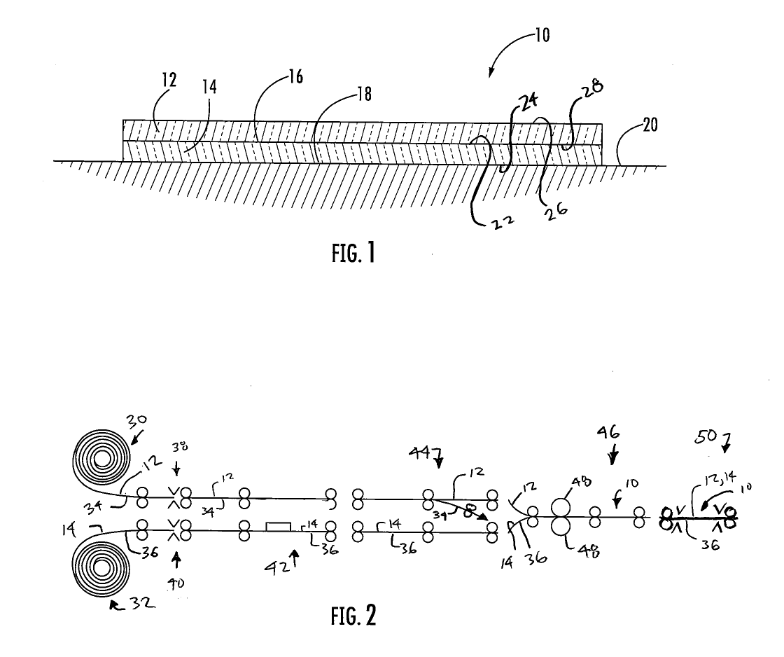

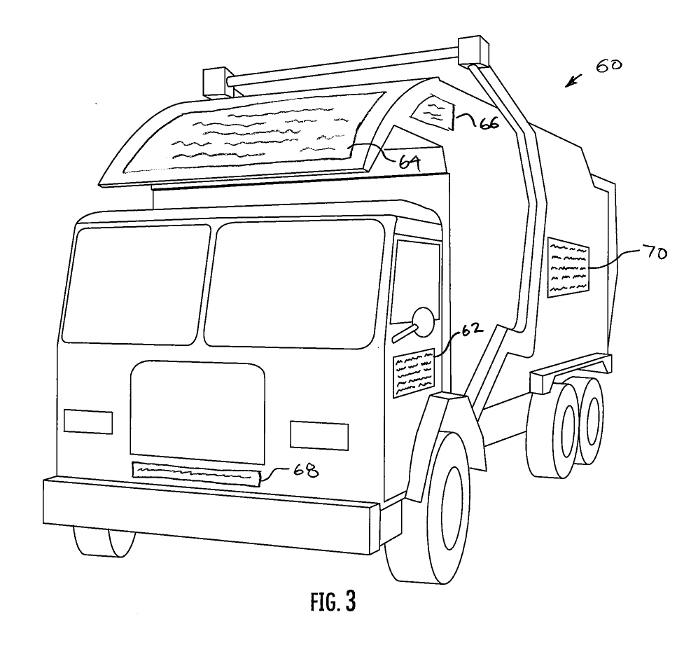

FIG. 2 shows a highly schematic view of manufacturing of laminate 10. As illustrated, top layer 12 is supplied from a source 30, which may be a roll (as illustrated) or already cut sheets. Film 12 in source 30 may already include a plasma corona treated surface, applied of adhesive, and applied protective layer as noted above. Alternatively, film 12 could comprise the extruded or blown raw film (e.g., ETFE) and those additional elements could be applied to the raw film. Such depends likely on the economics and/or logistics of sourcing of the film from a manufacturer and/or converter, etc., which is immaterial to the present disclosure.

Similarly, base layer 14 is supplied from a source 32 which may be a roll, cut sheets, etc. Base layer 14 may include adhesive, indicia such as via printing, and a protective layer, or such elements could be applied.

As illustrated in FIG. 2, sources 30 and 32 of layers 12 and 14 do include adhesives 16 and 18 and the protective films 34, 36 on lower (as shown) surfaces of the layers. The process of forming laminate 10 is shown as a single line driven by a plurality of pinch rollers, but such could be broken into various segments and not necessarily be continuous or at one location, as desired.

Cutting stations 38 and 40 are provided if needed to cut layers 12 and 14 into size for lamination. As shown, cutting stations are relatively upstream in the process, but if sheets are used as sources 30 and 32, such might not be needed. Also, cutting stations 38, 40 could be provided downstream of where illustrated, or eliminated if layers 12 and/or 14 are pre-cut to a desired size.

A decoration station 42 may be provided if decoration of layer 14 is desired. Decoration station 42 may be for example a digital printer for printing onto rolls, sheets, or cut pieces of layer 14.

A separation station 44 may be provided for removing protective layer 34 from top layer 12 just upstream of or as part of a lamination station 46. Alternatively, separation of protective layer 34 may be done manually before feeding stacked layers 12 and 14 into lamination station 46. Lamination station 46 may include two lamination rollers 48 for pressing layers 12 and 14 together so that adhesive 16 bonds the layers together tightly into laminate 10. Lamination station 46 may employ a cold lamination process if desired and if adhesive 16 is chosen accordingly. During lamination, protective layer 36 is still present on layer 14 (and may be kept there until laminate 10 is placed onto the desired surface 20).

A final cutting station 50 may be provided to cut the laminate 10 formed in lamination station 46 to its desired finished size if earlier cutting had not done so. The resulting laminate 10 (including protective layer 36) can then be shipped to an end user for application to a desired surface (after removing protective layer 36 on site).

FIG. 3 shows one general example of a vehicle 60 on which laminates 62, 64, 66, 68, and 70 have been respectively placed on a cab door, cab shield front, cab shield side, front of cab, and side of vehicle respectively. It should be understood that the illustrated vehicle and locations are examples only, and such laminates could be placed on any legally permissible horizontal, vertical, or other surface, on any such vehicle for decorational, informational, and/or protective purposes.

FIG. 4 shows one general example of laminates 72 and 74 being placed on a non-vehicle surface, in this case an informational kiosk 76 having an electronic screen 78. It should be understood that this is just one example showing that laminates could be placed on any desired non-vehicle surface at any orientation, including buildings, in indoor or outdoor locations, on fixtures, advertising displays, etc.

While preferred embodiments of the invention have been described above, it is to be understood that any and all equivalent realizations of the present invention are included within the scope and spirit thereof. Thus, the embodiments depicted are presented by way of example only and are not intended as limitations upon the present invention. Thus, while particular embodiments of the invention have been described and shown, it will be understood by those of ordinary skill in this art that the present invention is not limited thereto since many modifications can be made. Therefore, it is contemplated that any and all such embodiments are included in the present invention as may fall within the literal or equivalent scope of the appended claims

1. A protective film laminate for attachment to a surface, the protective film laminate comprising:
a base layer having a first side and a second side, the base layer including a polymeric film, the polymeric film including vinyl, the first side of the base layer having visible indicia thereon, the visible indicia including digitally-printed ink;
a top layer having a first side and a second side, the top layer including a clear polymeric film including a fluoropolymer;
a first adhesive layer located on the second side of the base layer for adhering to the surface; and
a second adhesive layer located on the second side of the top layer, the second adhesive layer including a pressure-sensitive adhesive and a UV-light blocker, the second adhesive layer adhering the second side of the top layer with the first side of the base layer thereby creating the protective film laminate, only the base layer and the top layer including films.

2. The protective film laminate of claim 1, wherein the clear polymeric film is transparent.

3. (canceled)

4. The protective film laminate of claim 1, wherein the fluoropolymer includes ethylene tetrafluoroethylene.

5. The protective film laminate of claim 1, wherein the first adhesive includes a pressure-sensitive adhesive.

6. (canceled)

7. The protective film laminate of claim 1, further including a protective layer removably attached to the base layer via the first adhesive layer for covering the first adhesive layer until contact with the surface.

8. The protective film laminate of claim 1, wherein the second side of the top layer has a corona treated surface.

9-11. (canceled)

12. A protective film laminate for attachment to a surface, the protective film laminate comprising:
a self-adhesive polymeric film having a display surface on a first side and a non-film first adhesive on a second side for attachment to the surface, the self-adhesive polymeric film including vinyl, the display surface having visible indicia thereon, the visible indicia including digitally-printed ink; and
a clear polymeric film having a first side and a non-film second adhesive on a second side, the clear polymeric film including a fluoropolymer, the non-film second adhesive including a pressure-sensitive adhesive and a UV-light blocker, the second side of the clear polymeric film being laminated onto the first side of the self-adhesive polymeric film via the non-film second adhesive thereby forming the protective film laminate.

13. (canceled)

14. The protective film laminate of claim 12, wherein the fluoropolymer includes ethylene tetrafluoroethylene.

15. The protective film laminate of claim 12, wherein the non-film first adhesive includes a pressure-sensitive adhesive.

16. (canceled)

17. The protective film laminate of claim 12, further including a protective layer removably attached to the self-adhesive polymeric film via the non-film first adhesive for covering the non-film first adhesive until contact with the surface.

18. The protective film laminate of claim 12, wherein the second side of the clear polymeric film has a corona treated surface.

19-33. (canceled)
